(19) United States
(12) Patent Application Publication
(10) Pub. No.: US 2006/0106729 A1
(43) Pub. Date: May 18, 2006

(54) Method and apparatus for restricting use of a computer program

(76) Inventor: Henry J. Roberts JR., Leavenworth, IN (US)

Correspondence Address: Brian L. Michaelis;Brown Rudnick Berlack Israels, LLP, One Financial Center, Boston, MA, 02111, US

(21) Appl. No.: 11/259,469

(22) Filed: Oct. 25, 2005

Related U.S. Application Data
(60) Provisional application No. 60/621,799, filed on Oct. 25, 2004.

(51) Int. Cl. H04L 9/00

(52) U.S. Cl. 705/59

(57) ABSTRACT

A method and apparatus for restricting the usage of a computer program is disclosed. A license table multiple data entries is generated. A unique table marker is stored on electronic media signifying the beginning of the table. The data entries follow the marker and contain encoded information relating to any number of usage restrictions imputed to a user by the program manufacturer. Upon authorization of use of the program the user is granted access to the program subject to the usage restriction defined by the manufacturer.

### CROSS REFERENCE TO RELATED APPLICATIONS

This application claims the benefit under 35 U.S.C. § 119(e) of co-pending and commonly-assigned U.S. Provisional application Ser. No. 60/621,799 entitled “System and Method of Authenticating Licensed Computer Programs” filed on Oct. 25, 2004, by Henry Roberts, which application is incorporated by reference herein.

### FIELD OF INVENTION

The invention relates to the use of computer programs, more particularly, a system and method of restricting licensed use of programs through a license table.

### BACKGROUND OF INVENTION

Many software manufacturers in the market today require a purchaser and end-user to obtain a license to use the manufacturer's software. Some programs contain a dialog box that appears during installation of the program with the license information. When an end-user signals they accept the terms and conditions of the license, usually by clicking an “ACCEPT” button, the program is then installed on the computer and the program is authenticated.

In advanced software environments however, it becomes difficult to monitor and control the licenses given out by a manufacturer to multiple end-users. Several software licenses are sold with usage restrictions that limit the number of users, or provide expiration dates. The multitude of types of usage restrictions coupled with the number of end-users who had purchased the program creates a difficult situation to maintain control over the usage of protected software programs.

In order to maintain control of the number of software applications sold and in use, the manufacturer must still use a license scheme to ensure the software is not being used or distributed illegally. It is common for software manufacturers to utilize a method of authentication in which the program, upon running, will search the hard disk of the computer to locate a license file. This file contains information that will authorize the computer to run the licensed program. A typical license file is stored on the hard disk and contains an encrypted key or number. The program then searches the hard disk for the license file and verifies the authenticity of the encrypted key contained therein. If the program code does not find the encrypted key or the key is not authenticated, the program initialization fails; if the key is present and authenticated, the program operation proceeds.

Software manufacturers, in order to maintain control over their software usually use a unique identifier of the computer on which the software runs to identify an authorized computer. For example, a license may contain an encrypted version of the media access control (“MAC”) address of the Ethernet card. The MAC address is a serial number that is unique to that piece of hardware. Upon initiation of the program, the code of the program searches the hard disk for the license file. The license file, provided separately by the manufacturer, contains an encrypted form of the MAC address. If this number in the license file, when decrypted, does not match the MAC address of the Ethernet card, the authentication fails. If the key matches the MAC address, the program continues to load. Other license schemes can employ unique identifiers for several other hardware devices in the system. For example, a scheme may use the type graphics card or the BIOS ROM which contains its own unique identifier.

Problems arise with this sort of scheme if the piece of hardware, to which the license is tied, requires replacement. Hardware like motherboards and graphics cards are replaced with great frequency and require the user to obtain a new license from the manufacturer that is tied to a new identifier on the replacement piece of hardware. Not only can this be a tedious and time consuming process, but it subjects the manufacturer to fraudulent requests for additional licenses. A user, in an attempt to defraud the manufacturer, can simply notify the manufacturer of the need for a new license due to a hardware failure. If the new license is provided and there is no hardware failure, the manufacturer has just given out a free license to its software. The manufacturer must decide either to provide the license or alienate the end-user by refusing the request for a new license, believing the request to be fraudulent.

Additionally, storing the license file that contains the authenticating information on the hard disk is problematic. Often a hard disk must be reformatted or repartitioned as part of disk maintenance or reconfiguration. These tools erase all data on the drive except for the information contained in the master boot record and the Partition table, in the process of creating and arranging new tracks and sectors on the disk. The reconfiguration of the disk requires the user to have to replace the license file, typically by requesting a new file from the manufacturer or using an archived copy of the file. In either case, it requires a new license file to be found or generated which can be costly and time consuming.

Other methods for authenticating a license include using an absolute location identifier for the license files. The program code looks to a specified fixed location on the hard disk to find the license file. If the license information is not in that specified location the program will not authenticate. Attempts to fraudulently copy all of the files to another computer will result in the license file being out of place, and prevent the product from being authenticated.

The difficulty of requiring an absolute location for a license file is that regular maintenance and equipment crashes can spoil the license scheme. Certain defragmenting tools increase hard disk efficiency by repositioning files on a hard disk, including the license file. The license file may reside on a data block that is repositioned during the defragmenting process. Upon initialization of the program, the license authenticating process can not find the license information in the correct location and the program authentication will fail. Additionally, if the hard disk crashes, the authorization to use the product is destroyed and the disk content is generally unavailable. Variations of different authentication schemes determine how catastrophic a crash must be to spoil the authentication process, however reformatting the disk, in all cases, will likely destroy the license file.

Other schemes used by leading companies in the field tie the authentication of the software to the serial number of the hard disk. The serial number itself is embedded in the electronics of the drive and cannot be altered or erased. As the license file contains a number that does not change and is not tied to other hardware in the computer, a new license is not needed upon the replacement of the hardware, such as the graphics or Ethernet cards. If, however, the drive itself is reformatted or repartitioned, the license file is still lost and must be regenerated or recopied. A replacement of the hard disk, and its serial number, will also require a replacement of the license file.

Another common technique is to duplicate the license information and write copies of it into several locations on the drive. This solution solves the problem of having to replace the license if the operating system is reinstalled or replaced, however, it does not prevent the license information from being destroyed if the hard disk is reformatted or repartitioned.

Many experts, including those from the most predominant company in the field have stated that there is no known solution to the issue of losing license files due to reformatting or repartitioning a hard disk. Currently, there is no successful method for authorizing a program or file to be used on a specific computer that can withstand reformatting, partitioning, regular maintenance, operating system reinstallation and/or crashes.

### SUMMARY OF INVENTION

A method and apparatus for authorizing licensed computer programs through the use of a license table is disclosed. The present invention creates a license table, upon installation of a software program, to a location of the hard disk where the data is immune to destruction from reformatting by Windows and Windows installation software. The program generates a license table from a dynamic link library (“DLL”). The license table is capable of containing entries for multiple programs organized by unique manufacturer identifiers and product identifiers, and usage restrictions as imposed by the terms of the license.

The present invention protects an end-user of a licensed software program from losing the license table under a variety of circumstances. The license information is not eradicated when the hard disk is reformatted or repartitioned. The license information is also not subject to destruction upon the relocation or deletion of files on the hard disk that may occur during regular maintenance of the drive, such as defragmentation or changes to the registry files.

The software manufacturer uses a DLL generator program, in accordance with the present invention, to generate a license table based on a manufacturer's unique identification number or code, and the product's unique identification number or code. The manufacturer may also use this DLL generator to include any usage restrictions during an evaluation period, such as the number of times the program may be used or the expiration date of the license.

The information from the DLL generated by the manufacturer is then compared to a license table during authentication. The license table is stored on the first track of the hard disk reserved for the master boot record and the partition table. The first track on the disk, track zero, lies below the level of the operating system and is not used for common data storage or file usage. Traditionally, the remaining space on the track after the Master Boot Record (“MBR”) and the partition table is left completely unused. Therefore changes to the operating system, such as reinstallation, do not affect the contents of the master DLL. This particular location on the hard disk is also not susceptible to reformatting or repartitioning as only the tracks after track zero are reapportioned and erased.

The end-user of the software, upon installation, is presented with a graphic user interface (“GUI”) requiring the input of certain information needed to authorize the program. The end-user contacts the manufacturer for an authentication key to authorize the use of the program. After the end-user enters the authorizing information, the key is transmitted to the DLL and a marker is set and stored in the license file on the first track of the hard disk signifying the user is authorized to use the program. The initialization of the program thereafter will look to the license table to verify the user is authorized to use the program.

This license file is not altered, deleted, or corrupted during reformatting, repartitioning, or most any computer crash. This presents a great advantage not only to the purchaser in not having to replace license files, but to the manufacturer as well. The manufacturer is protected from fraudulent users because the license table remains intact through all the above mentioned alterations to a hard disk. This includes restoration of a hard disk image in an attempt to “fool” the license as to the date and time restrictions in the license.

An embodiment of the present invention is also implemented over a computer network, such as the World Wide Web, or local access network. Secured transmission of all license and customer information allows the flexibility for license creation, validation, and authorization from remote locations.

Additionally, the present invention is adaptable for use with other types of storage media including, but not limited to flash drives. The methods and apparatuses disclosed herein can be implemented on any of various forms of storage devices that represents itself to an operating system as a hard drive. Drives formatted to work with a Linux operating system, or Macintosh operating system also contain unused, low-level areas that are immune to operating system reformatting procedures.

The present invention provides a robust system of protection for a software manufacturer as well as a more convenient manner for storing license information without the difficulties of reacquiring licenses upon hard disk alterations or hardware substitutions.

### DESCRIPTION OF DRAWINGS

The foregoing and other features and advantages of the present invention will be more fully understood from the following detailed description of illustrative embodiments, taken in conjunction with the accompanying drawings in which:

FIG. 1 is a block diagram of a typical layout of a data storage hard disk;

FIG. 2 shows the layout of license table, a partition table and master boot record area of a hard disk in accordance with an embodiment of the present invention;

FIG. 3 shows an interaction in accordance with an embodiment of the present invention;

FIG. 4A provides details of a license table in accordance with an embodiment of the present invention;

FIG. 4B illustrates a use of product in accordance with an embodiment of the present invention;

FIG. 4C provides details of a license table entry in accordance with an embodiment of the present invention;

FIG. 5 provides details of customizing a DLL in accordance with an embodiment of the present invention;

FIG. 6 is a graphical user interface used for setup of a DLL in accordance with an embodiment of the present invention;

FIG. 7 is a graphical user interface used for activation in accordance with an embodiment of the present invention;

FIG. 8A is a graphical user interface used for license management in accordance with an embodiment of the present invention;

FIG. 8B is a block diagram of the data flow of a license manager in accordance with an embodiment of the present invention;

FIG. 9A is a graphical user interface used for key generation in accordance with an embodiment of the present invention;

FIG. 9B is a block diagram outlining the flow of data in a key generation module in accordance with an embodiment of the present inversion;

FIG. 10 shows an interaction of components in accordance with an embodiment of the present invention; and

FIG. 11 is a block diagram of a data flow in a web-based implementation of an embodiment of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

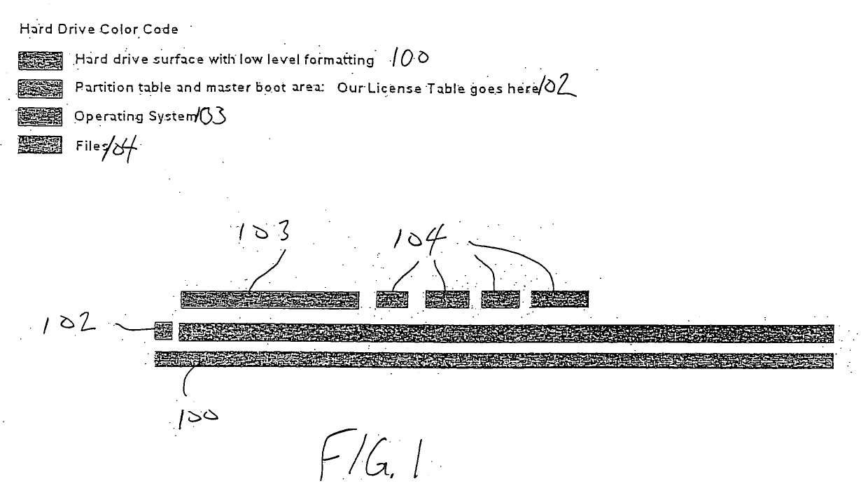

FIG. 1. shows the typical layout of a surface on a data storage hard disk. A typical drive contains certain layers of data that are used for particular functions. The hard disk surface 100 contains the low-level formatting such as the track and sector definitions. A first track, track zero 102, of the low-level formatted area becomes the location for the master boot record and the partition table. In accordance with an embodiment of the present invention, the license table containing the proper authenticating data is stored on the first track 102. The first track 102 is immune from alteration or destruction by any of the programs or files stored at a higher level, such as the operating system 103 and general file storage areas 104.

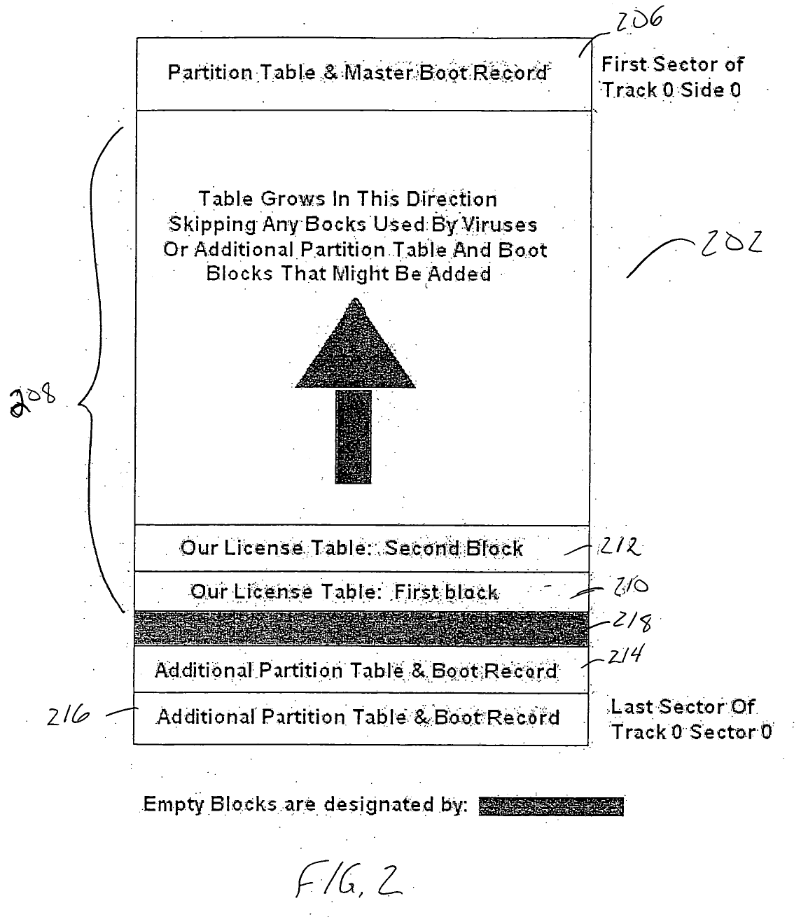

FIG. 2 shows a conceptual diagram of the first track 202 of a hard disk. The first sector 206 of track zero 202 contains the partition table and the MBR. In this embodiment additional partition table and boot record data is stored in the penultimate sector 214 and ultimate sector 216 of track zero 202. The license table 208, in this embodiment, begins in the 4th to last sector 210 of track zero 202 and expands forward toward the first sector 202 of track zero 202 leaving an empty sector 218 to allow additional space for the partition table or boot record.

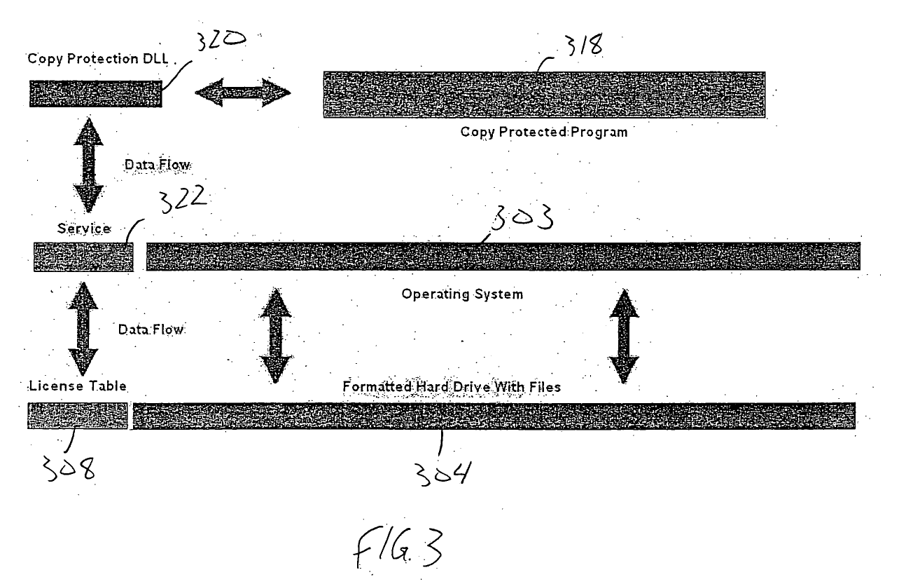

FIG. 3 details the data flow among the several components used in this embodiment of the invention. The copy protected program 318 communicates with a copy protection DLL 320, sending a request for authorization. A DLL, or Dynamic Link Library, as known in the art, is a collection of small programs which can be called upon when needed by an executable (.exe) program that is running. The DLL lets the executable program communicate with the drive and contains source code to perform copy protection functions as described in greater detail hereinafter. A service 322 transmits data blocks back and forth between the license table 308 and the copy protection DLL 320. The use of a service prevents the user from accessing the location where the license table is stored. The copy protection DLL 320 compares the unlocking key data to the entry in the license table 308. If the data from the license table 308 is a match with the data from the copy protection DLL 320, the authentication is successful and the copy protected program 318 continues its initialization and the remainder of the unlocking key is decrypted for the license limitation data.

Although the present embodiment is implemented on a hard disk media, one skilled in the art should recognize that any form of storage media may be utilized without deviating from the scope of the invention. Flash drives, or any mass storage device, can be utilized to accomplish the objectives of the present invention. The depiction of embodiments utilizing hard disk media are merely illustrative embodiments should not be construed as a limitation to the true scope of the invention.

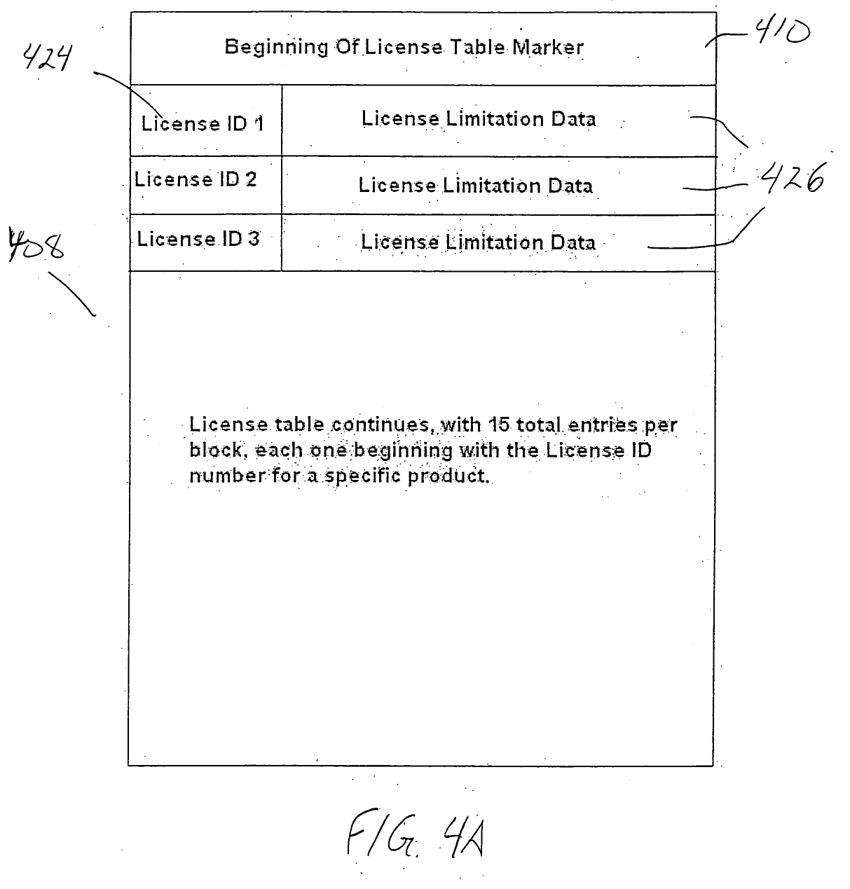

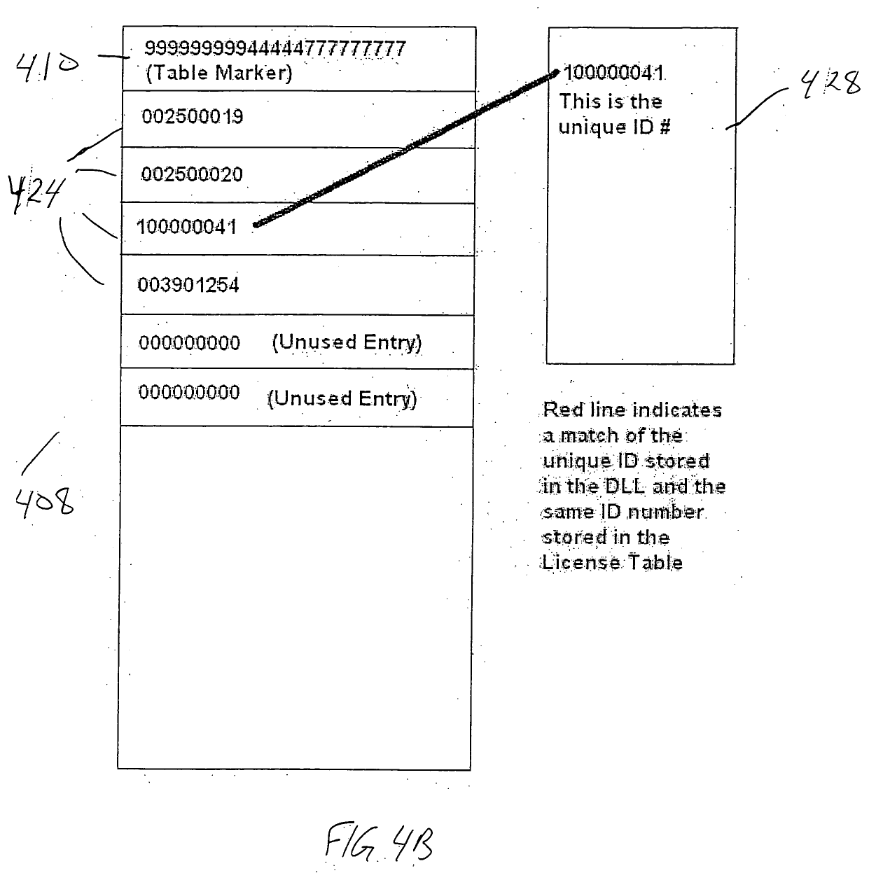

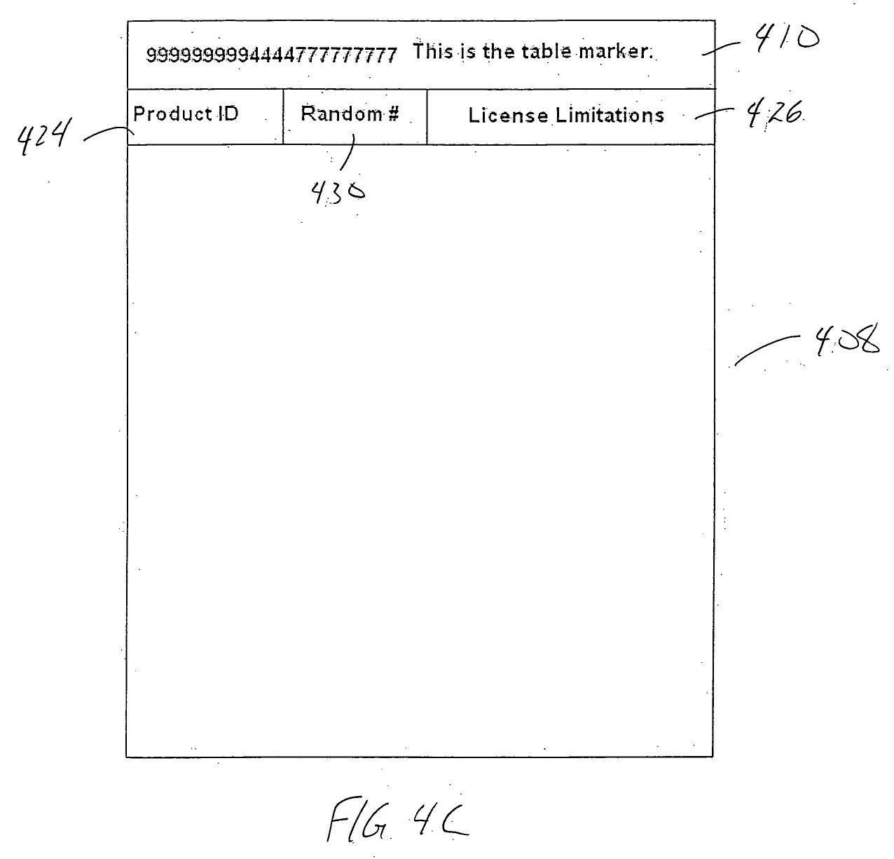

Turning now to FIGS. 4A-C, various aspects of one embodiment of a license table 408 are shown. FIG. 4A depicts a representation of the entire license table of this embodiment. The first block of the license table is a license table marker 410 signifying the beginning of the license table 408. The license table 408 is capable of managing multiple license identifications, or License IDs, 424 as well as specific limitation data 426 for each license. As explained below, the License IDs 424 are generated using a combination of unique customer and product identifiers. Each manufacturer is given a unique identifying number, called a Customer ID and each product is given a unique identifying number, called a Product ID. The license table is capable of growing to accommodate several different licenses.

FIG. 4B depicts the relationship between the license table 408 and the custom DLL 428. The customer and product ID numbers embedded in the custom DLL 428 are then combined so as to produce the License ID 424, and placed as the index number for that license table entry. In this embodiment, the custom DLL 428 calculates the License ID 424 by multiplying the Customer ID by 10,000 and then adding that value to the Product ID. The custom DLL 428 then searches for this number in the License Table 408 for validation. If the License ID is found in the license table 408, the authentication is a success and the product continues its initialization.

The License Table Marker 410 is a unique pattern of numbers which is extremely unlikely to be generated accidentally by any other program on a system. The License Table Marker 410, in this embodiment, for example, is a series of three numbers: 999999999, followed by 4444, followed by 777777777.

FIG. 4C depicts the break-down of the License ID 424 in the License Table, according to an embodiment of the present invention. The first time an License ID 424 is requested, the system generates and stores a random number 430 based on the day, and time. The random number 430 is then combined with the unique Product ID and any license limitations that may be implemented to form the License ID 424 and stored in the License Table 408. Advantageously nothing in the License ID 424 is related to any of the hardware contained in the system upon which the license is installed. Unlike previous methods where license identifiers, also termed Site Codes, were calculated from information gathered about the computer, e.g., hard drive serial numbers, the LAN Ethernet address, CPU, BIOS dates and release numbers, or etc., the License IDs 424 are not encoded into the hardware.

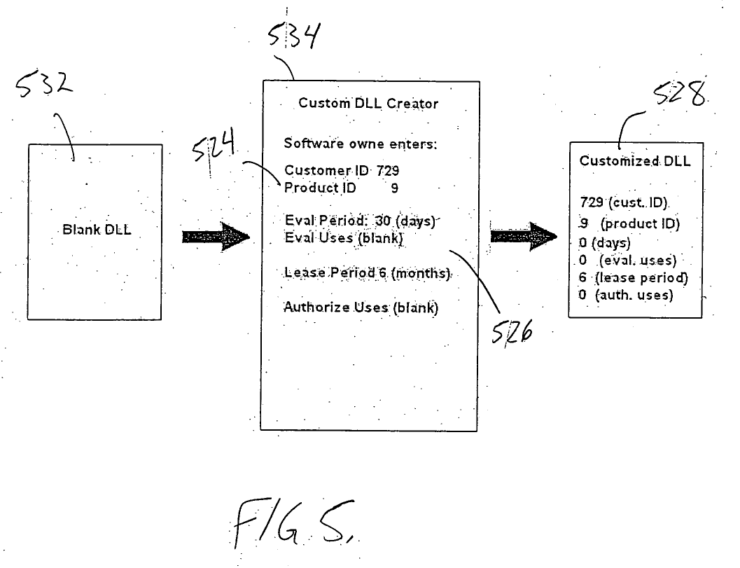

Turning now to FIG. 5, a diagram of the creation of a copy protection DLL 528 is shown. An embodiment of the present invention utilizes a utility, the custom DLL creator 534, to generate the copy protection DLL 528. The copy protection DLL 528 stores the unique identifier data 524 to be compared to the license table during authentication. The program files, upon installation, include a blank DLL 732. The custom DLL creator 534 takes the unique identifier data 524, for example in the form of a customer ID and a product or program ID, and encodes the input information into the copy protection DLL 528. This unique identifier information 524 includes the manufacturer identification and the product identifier, as well as any limitation data 526 used to restrict the license. For example, license limitation information may restrict the number of days of usage or evaluation uses, as well as the number of authorized uses or users. After the unique identifier data 524 and limitation data 526 are entered into the custom DLL creator 534, the manufacturer generates the copy protection DLL 528. This embodiment of the present invention processes the input information and stores the information in such a way into the copy protection DLL 528 that it can be compared to the license table when the end-user initiates the program.

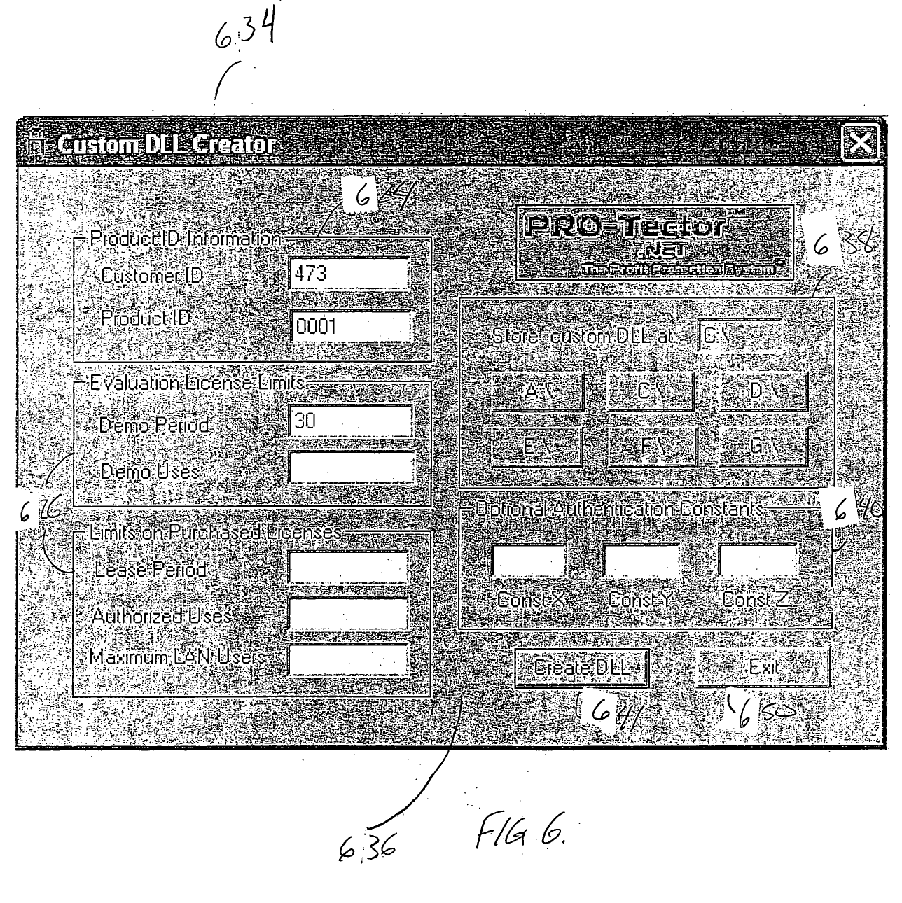

FIG. 6 depicts an example of a custom DLL creator graphical user interface (“GUI”) 636, in accordance with an embodiment of the present invention. The custom DLL creator GUI 636 is a data entry window through which the software manufacturer inputs the license identification 624 and limitation data 626 into the labeled fields of the custom DLL creator GUI 636. Here, the limitation data 626 includes the number of evaluation licenses as well as limits placed on purchased licenses. This method gives the software manufacturer greater flexibility over the types of licenses granted to end-users without having to generate and maintain individual classes of licenses. The manufacturer may also specify the drive location data 638 where the copy protection DLL will be stored.

Commercially available Software Development Kits, such as those provided by Microsoft and Sun Microsystems, contain forms of copy protection based on a DLL containing copy protection related functions. These protection functions can be defeated by simply creating a DLL of the same name that returns the expected value. For example, a DLL named filechck.dll and a function called “CheckLicense” is called to check to ensure the product is authorized to run. If the product is authorized to run, the function returns a value 10,000. The easiest way to defeat this is to create your own DLL, with a function named CheckLicense, and always returns the same value whether the product is authorized to run or not.

The present invention, in resolving the ease of creating imposter DLLs, implements an algorithm which converts incoming alpha/numeric/binary information into another value. This value is returned and verified against the expected value. The incoming value is termed the “challenge”. If the challenge is comprised of seemingly random values, then anyone intercepting the challenge and the response will not be able to identify what the proper response will be to subsequent challenges. This method is used between a copy protection DLL and the calling program to determine if the copy protection DLL is authentic or a customer generated fake designed to always return the correct value. The inventive embodiment further alters additional copy protection DLL's return information making the challenge an integral piece to the process the copy protection uses to verify a license.

This is accomplished by the calling program sending the copy protection DLL a pseudo-random number. The copy protection DLL uses a formula to convert that pseudo-random number into a value which encrypts one of the return values from the custom DLL. The calling program uses the same algorithm to calculate what the encryption value should be and applies that to the return value from the custom DLL. Once that is applied, the calling program knows the true return value from the custom DLL.

To prevent customers from bypassing the security of another customer by creating an imposter DLL, the challenge and response set of functions is customized using three values chosen by whoever installs the copy protection into any piece of software.

When the copy protection DLL is customized, the person using this copy protection can select three numbers, each with a three to five hundred range of values. These three numbers are in turn used by the challenge and response functions to create the value which will then be used to encrypt the return value. Each program publisher can easily and simply customize the algorithm, by defining the three core values used by the algorithm, so that any given user of the software cannot spoof the copy protection DLL of any other customer.

Software development functionality for C, Visual Basic, NET, and Delphi is provided to create and generate the custom DLL. Once the manufacturer has entered the appropriate data into the custom DLL creator GUI 636, the program generates the copy protection DLL when the manufacturer clicks the “Create DLL” button 641. The manufacturer may also abort the procedure by clicking the “EXIT” button 650.

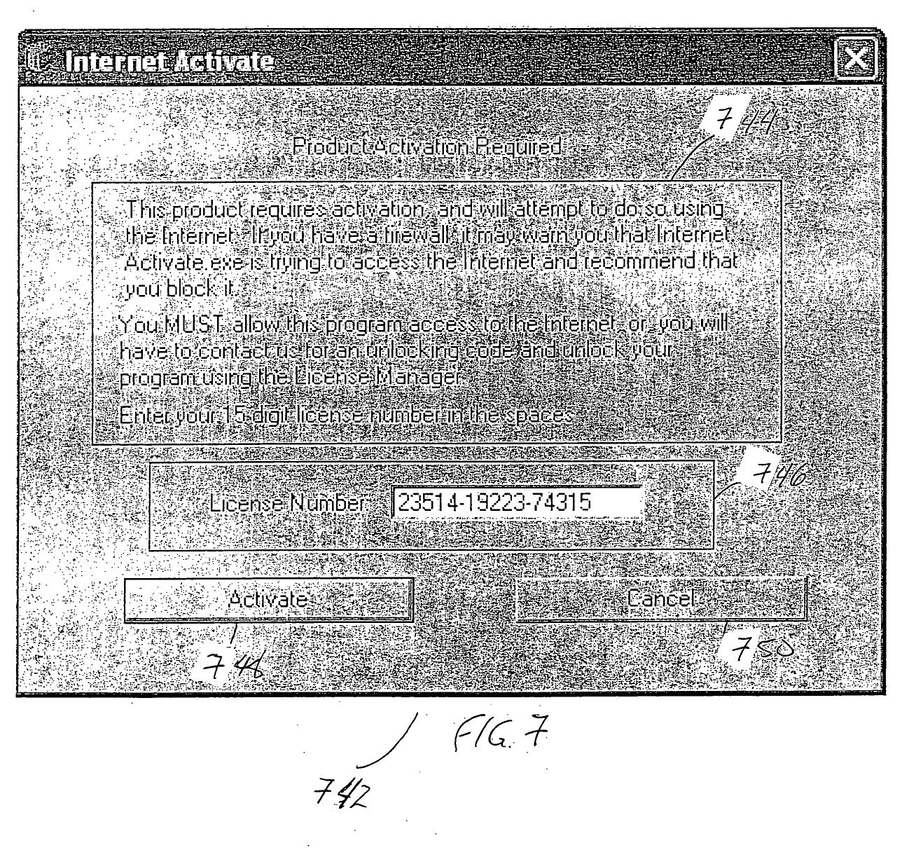

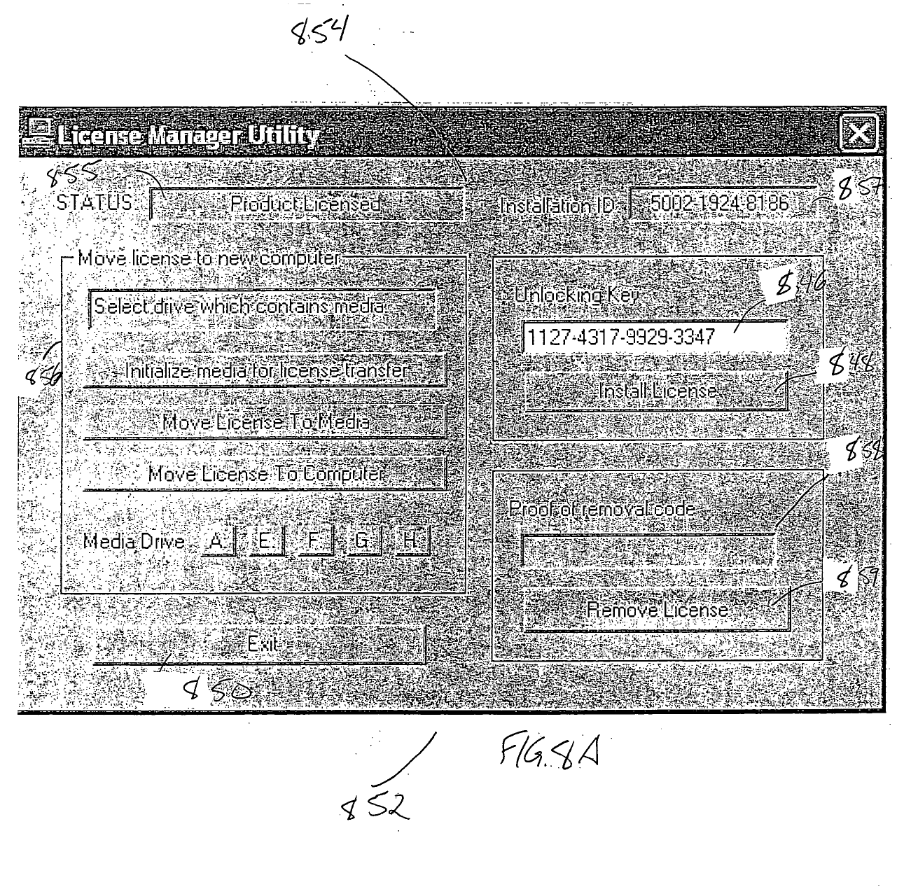

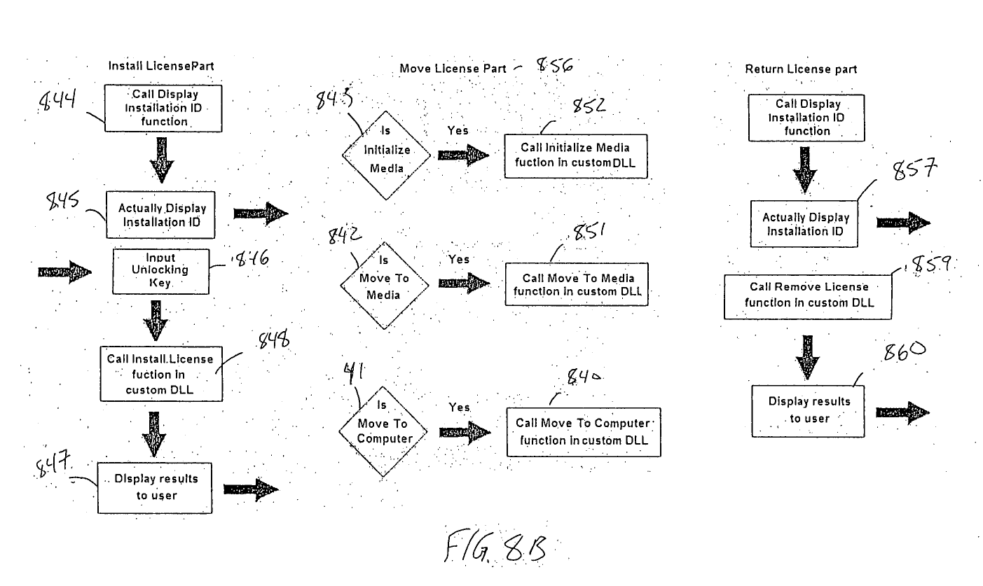

Turning now to FIG. 7 and FIG. 8A-B different embodiments of possible authentication GUIs, as seen by the end-user, are shown. The authentication GUI 742 of FIG. 7 appears to the end-user upon installation of the program. The authentication GUI 742 presents the end-user with a dialog box 744 giving the end-user instructions on how to activate or authenticate the program. The authentication GUI 742 accepts a license number 746. The license number 746 may be the same as the serial number for that product. In this embodiment, the license number 746 contains a true eight digit serial number, two checksum digits, and values for the remaining five characters which are the product identifier. Both the checksums and the product identifier may be encrypted, for example using the serial number as the encryption key. Once the license number 746 is acquired and entered, the end-user can activate the license by clicking the “ACTIVATE” button 748. The copy protection DLL and a support DLL send the license number 946 over the internet, along with a random number to a web site that converts the random number to a five digit unlocking key. The support DLL is a standard interface well known in the art which connects to the internet, if needed, and transfers the information back and forth to a remote web site. The information is transmitted through standard internet ports, such as port eighty, which allow text to be sent to and from the internet.

When the copy protection DLL receives the five digit unlocking key, it sets a value in that product's license table entry, to indicate that the product is properly authorized and licensed to be used. That table entry also contains the limitation data that may indicate that the license is limited by either time or uses or both. The end-user may also exit out of the authentication GUI by clicking the “CANCEL” button 750. The process of customizing the DLL allows the publisher to enter a lease period in months, and a number of uses, for example. When the product is unlocked over the Internet, these stored values are added to the already existing values in the license table. If no values exist, then they become the initial values, otherwise they are simply added to the existing value. Similarly, when user enters a five digit unlocking key or a standard sixteen digit unlocking key along with a series of values that are never used by the system, the unlocking process will use the limiting values in the copy protection DLL as limiting values for the license.

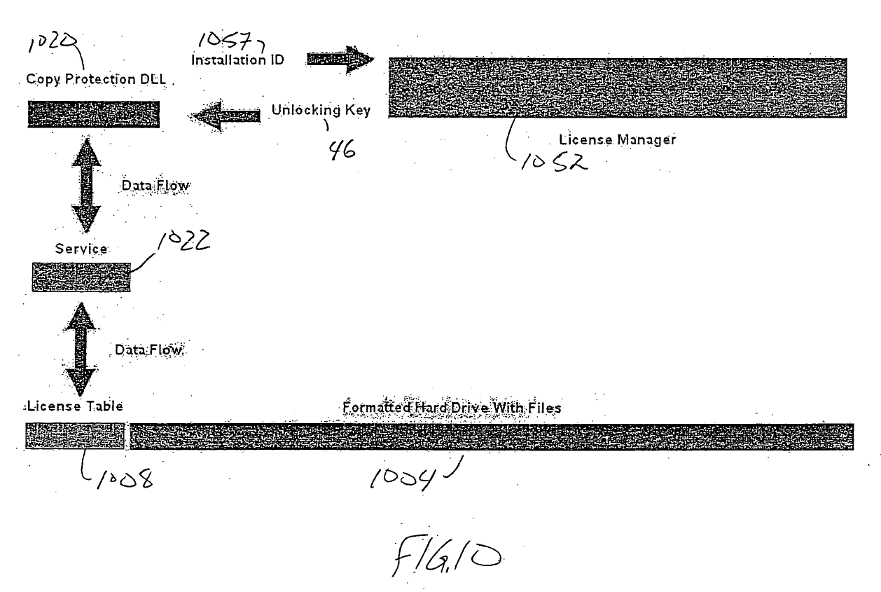

FIGS. 8A-B depict an embodiment of the present invention in which a License Manager Utility 852 is used to authenticate a license. FIG. 10A shows the utility GUI 854 displays a twelve digit installation ID 857 consisting of a ten digit random number plus two checksum digits. The end-user contacts the manufacturer and gives installation ID 857 to the manufacturer. The manufacturer then generates an unlocking key 846 and gives the key to the end-user. The end-user then enters the unlocking key 846 into the License Manager Utility 852 and clicks the “INSTALL LICENSE” button 848 and the authentication continues.

The License Manager Utility 852 also allows the end-user to relocate the license from one computer to another. The license-move utility 856 gives the end-user the option to initialize media for license transfer, move a license to selected media, or move a license to another computer, typically over a local area network. The License Manager Utility 852 also allows the end-user to remove the license from the computer. A removal code 858 is obtained from the manufacturer and entered into the utility GUI 854. The end-user, by clicking on the “REMOVE LICENSE” button, is able to cancel the license on that computer. In this embodiment, the “REMOVE LICENSE” function returns two twelve digit numbers: A twelve digit Installation ID, or site code, and a twelve digit proof of removal code, five digits of which are the proof of removal itself, two digits are checksums, and the remaining four digits are the number of uses the customer had remaining at the time the license was removed. Both twelve digit numbers are transmitted to the manufacturer, who then uses one of the functions in the copy protection DLL to decrypt and verify the Proof Of Removal Code. Both twelve digit numbers are passed to the proof of removal library function, which then verifies the core five digit proof of removal code is correct, decrypts the remaining seven numbers, verifies the checksums, returns a code indicating the proof of removal code was valid, and returns any uses left. The end-user may also abort the authentication by clicking the “EXIT” button 850.

A diagram of the data flow of the License Manager Utility is shown in FIG. 8B. A call to the Display Installation ID function 844 is called and the Installation ID is displayed 1045. The unlocking key 846 is input and a call to the License Install function 848 in the Custom DLL is made. The results are then displayed to the user 847. Upon selection of the “Initialize media for license transfer” feature 843 a call is made to a function in the Custom DLL to initialize the media for a license transfer 852. If the user selects the “Move License to Media” feature 842 a call is made to a function in the Custom DLL to move the license to the specified media 851. Upon selection of the “Move License to Computer” feature 841, a call is made to a function in the Custom DLL that initiates a move of the license to the computer 840.

If a user wishes to display the license or remove the license, the License Manager Utility 852 is invoked. A call to the Display Installation ID function is made 844 and the ID is displayed 857 in the GUI to the user. If a user should wish to remove the license, a call is made to a function in the DLL to destroy or delete the license 859 and the results confirming or denying the removal are displayed to the user 860.

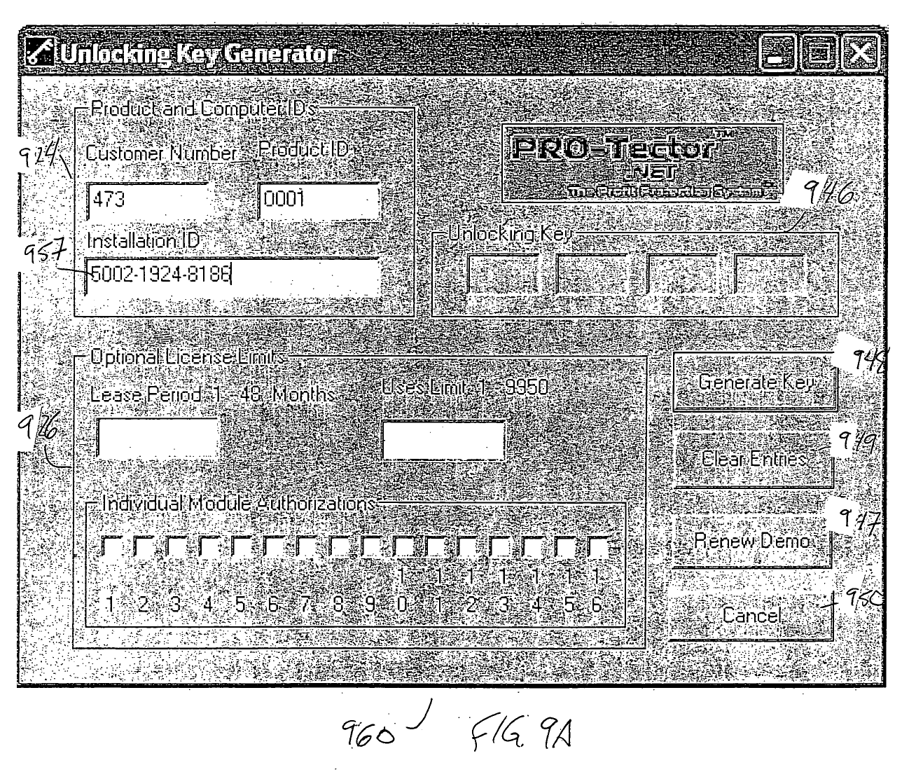

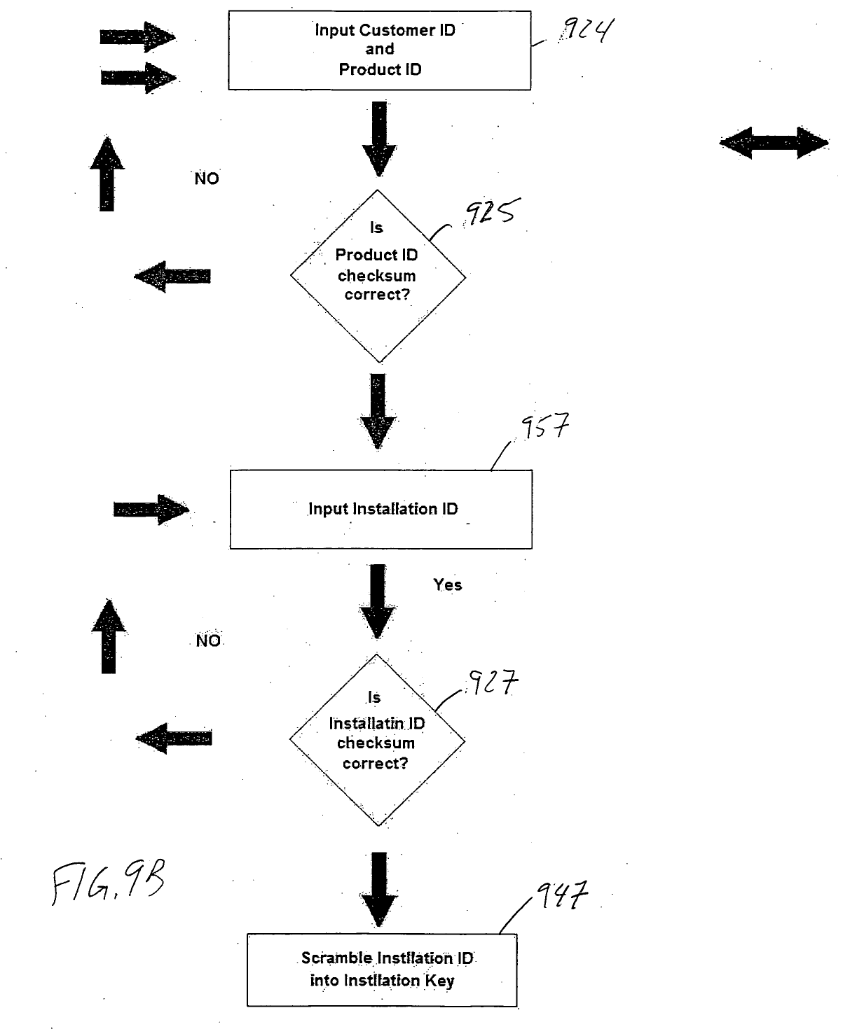

FIG. 9A-B depict an embodiment of the present invention having an Unlocking Key Generator 960 that the manufacturer uses to generate the unlocking key 946 after the end-user has notified the manufacturer of the installation ID 957. FIG. 9A illustrates the GUI of the Unlocking Key Generator 960. To generate the unlocking key 1146, the manufacturer enters the unique identifier data 924, and the installation ID 957, obtained from the end-user. The manufacturer may also enter license limitation data 926 that will translate into the unlocking key 946. The manufacturer then presses the “GENERATE KEY” button 948 and the unlocking key 946 is displayed. The manufacturer then can notify the end-user of the unlocking code 946. The manufacturer may also empty all fields of text by pressing the “CLEAR ENTRIES” button 949. Additionally, the manufacturer can renew an end-user's demo license simply by clicking the “RENEW DEMO” button.

Turning now to FIG. 9B, the data flow of information through the Unlocking Key Generator 960 is illustrated. Upon initiation, the GUI is displayed and the user inputs the Customer ID and the Product ID 924. The checksum of the Product ID is authenticated 925. If the Product ID checksum is not validated, an error is returned. If the Product ID checksum is validated, the Installation ID is input 957. The checksum of the Installation ID is then authenticated 927. If the checksum is not validated, an error is returned. If the checksum is validated, the Installation ID is scrambled into the Installation, or unlocking, key 948 as explained below.

Turning now to FIG. 10, a system diagram of the data flow of an embodiment of the present invention is shown. The license manager 1052, after having processed the installation ID 1057 entered by the manufacturer, transmits the unlocking key 1046 to a copy protection DLL 1020. The copy protection DLL 1020 receives the unlocking key 1046 and compares the authentication data of the unlocking key 1020 to the data in the license table 1008. If the authentication data of the unlocking key 1046 matches the data in the license table 1208 the copy protection DLL 1020 then decodes the remainder of the unlocking key 1046, extracting the license limitation data. The copy protection DLL 1020 then sets the status value in that product's license table 1008 entry and processes the license limiting data. The license table 1008 is isolated from the portion of the hard disk 1004 containing the rest of the computer's data files. The license table 1008 is immune from destruction from reformatting, repartitioning, operating system reinstallation and many equipment crashes.

The present invention is apt for utilization with any type of storage media. Flash drives can be chosen as the media upon which the License Table is stored. The implementation of the present invention on Flash media is identical to that of the hard disk media implementation, with few trivial exceptions. Similarly to hard disks, Flash media devices contain low-level areas that are not typically used by operating system programs. Placing the license table in this area protects it from alteration and reformatting by an operating system or any other program dependant on the operating system. A Flash media implementation, due to structural differences, does not require the placement of the License Table in a boot sector, nor does it require altering a boot sector to accommodate and access a License Table. The present invention can be implemented upon any mass storage device, and the embodiments described herein should not be construed as a limitation of the true scope of the present invention.

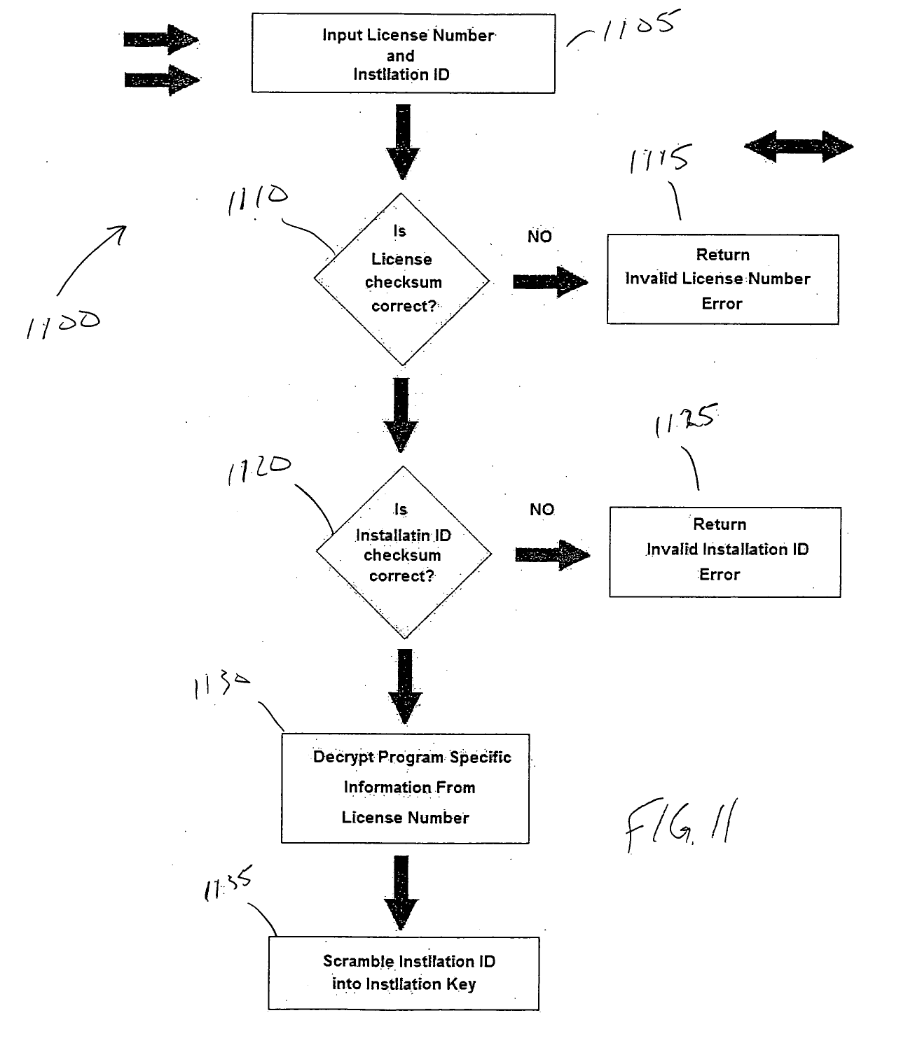

Turning now to FIG. 11 a sequence 1300 in accordance with an embodiment of the present invention implemented over the World Wide Web (“the Web”) is shown. Web activation is accomplished by generating unlocking keys through a robot web site based interface. The use of a web site interface allows for an automated processing of the sequence. The copy protected DLL sends the web site an Installation ID and a license number. Upon verifying the validity of the license number, the web site generates the correct unlocking key and returns it via the internet.

Each license number is generated, using the customer ID, the product ID, and an eight-digit serial number, which can be either a single eight-digit serial number, or made up of the customer ID and a set of serial numbers for each customer ID. The license number comprises the following parts:
(True license number) (checksum 1) (checksum2) (encrypted product ID)
   The license number is 8 digits, each checksum 1 digit, and the encrypted product ID 5 digits, for a total of 15 digits. For example, the license number would start as the 8 digit base license (or serial) number:
43250001_{— — — — — — —}
   The product ID is then added.
43250001_{— —}00157.
   This license number is sent 1105 to the web site, along with the installation ID, to the robot web site.

The web site first verifies the license checksum 1110. If the license checksum is not validated the sequence returns an error reporting an invalid license number 1115. If the license checksum is verified, the installation ID checksum is checked 1120. If the license checksum is not validated the sequence returns an error reporting an invalid installation ID 1125. If the checksums verify, the sequence the encrypts the program specific information from the license number 1130. The unlocking key then is generated by scrambling the installation ID 1135. This number is returned, via the network, to the program which initiated the sequence 1100. The unlocking key is verified and the new license table entry is placed in the License Table. If the web robot encounters an error, such as an invalid license number, it returns a negative error code to identify which error occurred.

While the illustrative embodiments presented herein have been described as being implemented over the Web, one skilled in the art should recognize that any data transmission network, i.e. local area networks, wide area networks, etc. may be implemented without deviating from the scope of the invention.

Although the illustrative embodiments discussed herein have been described in the context of having specific types of license limitation data, such as expiration dates or authorized number of uses, one skilled in the art should appreciate that any of various other license restriction or limitation conditions could be used in combination with the authentication of a license. For example, specifying which parts of a program may be used, and any usage limitations placed on each part. Other limitations can be the number of concurrent users on a network, country or region codes, where a product would be authorized, or the number of times specific actions can be repeated—such as moving the license from one computer to another.

Although the illustrative embodiments discussed herein have been described in the context of having a license table identified by a table marker, one skilled in the art should appreciate that the license table markers and their arrangement, including the data stored therein could be changed and rearranged without deviating from the true spirit of the invention. The table marker may take any form which will be unique and not found on a storage media device accidentally. It can be any combination of numbers, bytes, or simply a specific pattern of bytes spaced in the data block. For example, in an embodiment in which the license table starts out as all zeros, any non zero value could be placed in the first byte, another non zero value could be placed in the third byte, another non zero byte placed in the sixth byte, and so on. The resulting pattern being:
Byte 1: 0, Byte 2: (non zero), Byte 3: zero, Byte 4: zero, Byte 5: non zero, Byte 6: zero, Byte 7: zero, byte 8: zero, byte 9: nonzero
   With X representing any non-zero value, the table marker, in this implementation may appear as:
0 X 00 X 000 X.
   As such, any recognizable pattern can be used for the license table marker in accordance with the present invention.

Although the illustrative embodiments discussed herein have been described in the context of identifying programs with unique product identifiers for each separate program, one skilled in the art should appreciate that the product identifiers could be replaced by any of various unique identifiers that can be authenticated, such as a 64-bit random number based, in part, on a combination of the date and time of installation or first use. Alternatively, the date and time of the installation or first use could be used to create a number unique to that computer.

Although the illustrative embodiments discussed herein have been described in the context of storing the license table on the first track of the hard disk, one skilled in the art should appreciate that the license table may be stored elsewhere on the drive where it could be made immune from destruction reformatting, such as a specifically created partition at the end of the disk large enough to hold the license table only.

Although the illustrative embodiments discussed herein have been described in the context of storing the license table on the first track of the hard disk, one skilled in the art should appreciate that the license table may be stored elsewhere on the drive where it would be immune from destruction operating system changes or reinstalls, such as in a pre-defined portion of the system files that had been marked as bad blocks.

Although the illustrative embodiments discussed herein have been described in the context of customizing the copy protection DLL itself and storing the unique identification data directly in the DLL data area, then creating the license table, one skilled in the art should appreciate that the process could be reversed by creating that unique identifier number during installations, storing that number in the license table and in the custom DLL.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for restricting the use of a protected computer program comprising:
generating a license table comprising a marker and a plurality of table entries, the marker signifying the beginning of the table;
encoding a usage limitation into a license identifier;
storing the license identifier in a table entry of the license table, the license table stored on an electronic media device;
receiving a request for authorization from a user, the request containing an key;
comparing the key to the plurality of entries in the license table,
decoding the license identifier to obtain the usage limitation for the computer program upon finding a corresponding table entry for the key; and
granting access to the computer program subject to the usage limitation decoded from the license identifier.

2. The method of claim 1 further comprising storing a plurality of usage limitations in a dynamic link library, the dynamic link library generating the license identifier by encrypting a usage limitation into a computer readable form, the dynamic link library storing the license identifier in the license table and storing the license table on the electronic media device.

3. The method of claim 1 wherein in the step of storing the license table further comprises storing the license table in the first track of hard disk, the first track unaffected by the operating system and any computer program dependent thereon.

4. The method of claim 1 wherein in the step of storing the license table further comprises storing the license table on a flash memory device.

5. The method of claim 1 wherein in the step of storing the license table further comprises storing the license table on a mass storage device.

6. The method of claim 1 wherein the step of generating the license identifier further comprises encoding a customer identifier and a product identifier into the license identifier, the key comprising the customer identifier and the product identifier.

7. The method of claim 1 wherein the step of encoding a usage limitation further comprises encoding an expiration date into the license identifier.

8. The method of claim 1 wherein the step of encoding a usage limitation further comprises encoding an maximum number of users into the license identifier.

9. The method of claim 1 wherein the step of encoding a usage limitation further comprises encoding a geographic restriction into the license identifier.

10. A system for restricting the use of a protected computer program comprising:
a license table comprising a marker and a plurality of table entries, the marker signifying the beginning of the license table; and
a library comprising a plurality of usage limitations the library encrypting the usage limitations to form a license identifier, the library storing the license identifier as a table entry in the license table; the library comparing a key transmitted by a user to the license identifier, the library allowing for the use of the program upon matching the license identifier to the key subject to the usage limitation.

11. The system of claim 10 wherein the license table is stored in the first track of a hard disk, the first track unaffected by an operating system and any programs dependent thereon.

12. The system of claim 10 wherein the license table is stored in a flash memory drive.

13. The system of claim 10 wherein the library further comprises a plurality of customer identifiers and a plurality of product identifiers, the library encoding a customer identifier and a product identifier into the license identifier.

14. The system of claim 10 wherein the usage limitation comprises an expiration date.

15. The system of claim 10 wherein the usage limitation comprises a maximum number of uses.

16. The system of claim 10 wherein the usage limitation comprises a geographic region code, the geographic region code restricting the use of the computer program to a geographic region of the world.

17. A method of restricting the use of a protected computer program:
storing a plurality of customer identifiers, a plurality of product identifiers, and a plurality of usage restrictions in a dynamic link library;
encoding a customer identifier, a product identifier and a usage restriction into a license identifier;
storing the license identifier in a license table, the license table comprising a marker signifying the beginning of the license table, the license table stored on an electronic media device;
receiving an authorization request to the library, the request comprising a key, the library comparing the key to the license table; and
granting access to the program, the library allowing access to the program upon finding a license identifier corresponding to the key, the granting access to the program subject to the usage limitation of the license identifier.

18. The method of claim 17 further comprising encoding a plurality of random numbers into the license identifier.

19. The method of claim 17 further comprising encoding at least one checksum value into the license identifier.

20. The method of claim 17 further comprising storing the license table on the first track of a hard disk, the first track of a hard disk unaffected by the operating system and any program dependent thereon.

21. The method of claim 17 further comprising storing the license table on a flash memory device.
